(19) United States
(12) Patent Application Publication
(10) Pub. No.: US 2008/0226442 A1
(43) Pub. Date: Sep. 18, 2008

(54) FAN WITH MEANS FOR MONITORING WEAR

(75) Inventors: Olivier DARNIS, Bruguieres (FR); Francois Gauharou, Cugnaux (FR)

Correspondence Address: SUGHRUE MION, PLLC, 2100 PENNSYLVANIA AVENUE, N.W., SUITE 800, WASHINGTON, DC, 20037, US

(73) Assignee: TECHNOFAN

(21) Appl. No.: 12/047,354

(22) Filed: Mar. 13, 2008

(30) Foreign Application Priority Data
Mar. 14, 2007 (FR) 07 53827

(51) Int. Cl. G01M 13/04; G01M 7/00

(52) U.S. Cl. 415/118; 702/34

(57) ABSTRACT

The fan comprises a support structure, a wheel which is carried by a shaft which is coupled to a drive motor and at least one ball-bearing which is interposed between the shaft and the support structure, the support structure comprising an outer conduit which encloses a bulb-like portion which has a chassis for supporting the drive motor and the wheel, the outer conduit and the bulb-like portion delimiting an annular channel for circulation of air which is caused to move by the wheel, the fan comprising means for monitoring the ageing of the bearings.

The means for monitoring the ageing comprise:
a sensor for measuring a mechanical parameter which is representative of the dynamic behaviour of the or each bearing, which sensor is arranged in the inner space delimited by the annular channel for circulation of the air;
a processing chain which is connected to the measurement sensor and which is capable of calculating at least one indicator which is representative of the vibration behaviour of the bearing based on the parameter measured and evaluating the or each indicator which is representative of the vibration behaviour of the bearing from the sensor with respect to at least one predetermined criterion.

### TECHNICAL FIELD

The invention concerns a fan with means for monitoring wear.

### BACKGROUND TO THE INVENTION

The present invention relates to a fan of the type comprising a support structure, a wheel which is carried by a shaft which is coupled to a drive motor and at least one ball-bearing which is interposed between the shaft and the support structure, the support structure comprising an outer conduit which encloses a bulb-like portion which has a chassis for supporting the drive motor and the wheel, the outer conduit and the bulb-like portion delimiting an annular channel for circulation of air which is caused to move by the wheel, the fan comprising means for monitoring the fatigue of the bearings.

The ventilation circuits of aircraft include fans for circulating air in ventilation sheaths. These fans rotate at high speed and must be highly reliable. In order to comply with these requirements, the shaft supporting the wheel of the fan is carried by two ball-bearings. These bearings are lubricated in order to prevent them from becoming hot and rapidly being destroyed.

The fracture of a fan of this type can be extremely disruptive for the aircraft in which it is fitted since it provides ventilation for the passengers. This fan is thus subject to a very rigorous maintenance schedule, involving regular checks and frequent replacement of wear components, and in particular the ball-bearings, before they can be completely damaged.

Such a maintenance schedule and premature replacement of wear components are found to be costly in terms of the use of the aircraft.

WO-03/020582 describes a device for monitoring the deterioration of a fan, comprising a sensor which is fitted to the outer structure of the fan. This device allows a malfunction of the fan to be detected and in particular the repeated impacts of the blades of the fan against the outer conduit of the fan, these impacts potentially leading to the production of odours or fumes.

This device allows only malfunctions of the fan to be detected and does not allow the malfunctions to be predicted before they occur, which requires the implementation of a costly preventive maintenance operation.

### SUMMARY OF THE INVENTION

The object of the invention is to provide a fan which allows maintenance costs to be reduced.

To this end, the invention relates to a fan of the above-mentioned type, characterised in that the means for monitoring the ageing comprise:

a sensor for measuring a mechanical parameter which is representative of the dynamic behaviour of the or each bearing, which sensor is arranged in the inner space delimited by the annular channel for circulation of air;

a processing chain which is connected to the measurement sensor and which is capable of calculating at least one indicator which is representative of the vibration behaviour of the bearing based on the parameter measured and evaluating the or each indicator which is representative of the vibration behaviour of the bearing from the sensor with respect to at least one predetermined criterion.

According to specific embodiments, the fan comprises one or more of the following features:

the measurement sensor is an acceleration meter;

the measurement sensor is a piezoelectric sensor;

the monitoring means comprise a single measurement sensor;

the measurement sensor is pressed directly onto a ring of a bearing;

the measurement sensor is pressed onto the support chassis in the immediate vicinity of a bearing;

the processing chain comprises means for frequency analysis of the mechanical parameter measured by the measurement sensor over a frequency range of between at least 0 and 10 kHz and the indicator which is representative of the vibration behaviour is a function of the frequency components of the parameter measured by the measurement sensor between at least 0 and 10 kHz;

the processing chain comprises means for frequency analysis of the mechanical parameter measured by the measurement sensor over a frequency range of between at least 0 and 20 kHz and the indicator which is representative of the vibration behaviour is a function of the frequency components of the parameter measured by the measurement sensor between at least 0 and 20 kHz;

the indicator which is representative of the vibration behaviour is a root mean square of all of the frequency components of the parameter over the entire frequency range.

The fan according to any one of the preceding claims, is characterised in that the processing chain comprises:

means for frequency sampling of the parameter measured by the measurement sensor;

means for frequency analysis of the parameter measured by the measurement sensor providing a frequency component (Vᵢ) for each frequency;

means for calculating the or each indicator which is representative of the vibration behaviour in accordance with the frequency components received;

means for comparing the indicator with at least one reference value.

The invention will be better understood from a reading of the following description, given purely by way of example and with reference to the single FIGURE.

### BRIEF DESCRIPTION OF THE DRAWING

FIG. 1 is a longitudinal section of a fan according to the invention.

### DESCRIPTION OF PREFERRED EMBODIMENTS

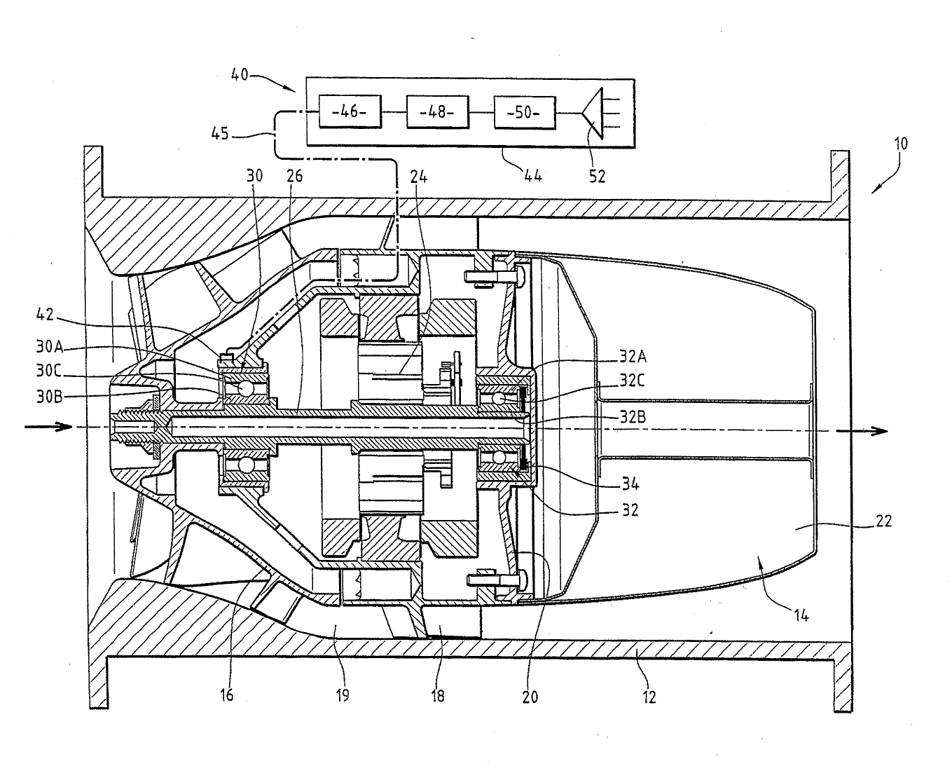

The fan 10 illustrated in FIG. 1 is intended to be placed in a ventilation circuit of an aircraft. It comprises a support structure 11 which comprises in particular a tubular outer conduit 12 and a bulb-like portion 14 which is arranged inside the conduit, a wheel 16 being mounted so as to be able to be moved in terms of rotation about the bulb-like portion.

The bulb-like portion 14 is connected to the conduit 12 by means of transverse arms 18 so that an annular channel 19 is delimited between the tubular conduit 12 and the bulb-like portion 14.

The bulb-like portion 14 has a chassis 20 which carries a fairing 22. The tubular conduit 12 is rigidly connected to the chassis 20 in order to form the support structure.

An electric motor 24 is carried by the chassis and is arranged inside the fairing 22. It is arranged along the axis of the fan. The motor 24 has a shaft 26 which carries the wheel 16 at the end thereof. In the embodiment illustrated, the wheel 16 conforms to the shape of the bulb-like portion 14. The wheel is arranged at the side of the bulb-like portion 14 via which the air is drawn in.

The rotor of the motor is fixedly joined to the shaft 26 whilst the stator of the motor is fixedly joined to the chassis 20.

The shaft 26 of the motor is carried by two ball-bearings 30, 32.

The bearings are arranged at one side and the other of the motor 24, a bearing 30 referred to as the front bearing being arranged between the motor 24 and the wheel 16 whilst the other bearing 32 referred to as the rear bearing is arranged opposite the wheel 16 relative to the motor 24.

As known per se, each bearing comprises an outer ring 30A, 32A which is fixedly joined in terms of rotation relative to the chassis 20 and an inner ring 30B, 32B which is fixedly joined in terms of rotation to the shaft 26 and bearing elements, in particular balls 30C, 32C which are interposed between the two rings.

A cage for retaining the balls, formed by a cylindrical hoop through which receiving members for the balls extend provides equal distribution of the balls and correct positioning of the balls between the two rings.

The rear bearing 32 is loaded axially with resilient washers 34 which are arranged around the shaft 26 and which are pressed between the outer ring 32A of the bearing and the chassis 20. These resilient washers form a spring and push the outer ring of the bearing towards the wheel 16.

The front bearing 30 has larger dimensions than those of the rear bearing 32. The bearing 30 is subject both to the load of the spring 34 and the resultant aerodynamic thrust of the wheel 16.

According to the invention, the fan comprises means 40 for monitoring the fatigue of the bearings.

These means comprise a sensor 42 for measuring a mechanical parameter which is representative of the dynamic behaviour of the bearings of the fan. This sensor is arranged in the inner space delimited by the annular channel 19. It is placed on the chassis 20 or on one of the outer rings 30A, 32A of a bearing. The sensor is in any case in the immediate vicinity of one of the bearings and, more precisely, either in direct contact with the bearing ring or in direct contact with a component which is directly connected to the bearing ring.

According to a first embodiment, the sensor is an acceleration meter. According to another embodiment, the measurement sensor is a piezoelectric sensor which is capable of measuring the deformations of the component on which it is placed.

The means 40 for monitoring the fatigue of the bearings further comprise a processing chain 44 which is connected to the sensor 42.

In the embodiment illustrated, the processing chain is arranged at the outer side of the air channel so that the sensor 42 is connected to the processing chain by means of conductors 45 which extend along the support structure and which extend through the annular air channel 19 via the transverse arms 18.

The processing chain first comprises a sampler 46 which is capable of sampling the signal received from the sensor 42. For example, this sampling is carried out with a frequency of 50 kHz so that 50,000 samples per second are collected at the outlet of the sampler. The outlet of the sampler is connected to a unit 48 for frequency analysis of the signal. This unit is, for example, capable of providing a direct Fourier transform of the parameter samples collected.

It thus provides, at the outlet, frequency samples or frequency components designated Vᵢ. These frequency samples correspond to a frequency range of at least 0 to 10 kHz and preferably at least equal to 0 to 20 kHz, a frequency sample being provided for every half-hertz, that is to say, at least 20,000 or 40,000 frequency samples are provided.

The measurement chain comprises a module 50 for calculating an indicator of the vibration behaviour designated Ind. This module is capable of providing a calculation of the indicator Ind from the frequency samples Vᵢ received from the unit 48 over the entire frequency range.

Preferably, the indicator designated Ind is determined by the formula:

$$Ind = {k}_{1} \sqrt{{\sum }_{i = 1}^{n} \frac{{V}_{i}^{2}}{X}} - {k}_{2} \sqrt{{\sum }_{j} \frac{{V}_{j}^{2}}{X}} \qquad ( Formula 1 )$$

where k₁, k₂ are constant
Vᵢ, Vⱼ are frequency samples
“i, j” is the identification of the sample
X is a coefficient dependent on the window function
n: is the number of frequency samples.

In this manner, the indicator is the difference between a first root mean square I₁ of all of the frequency samples over the entire frequency range and a root mean square I₂ of only specific frequency samples, these samples corresponding to the frequencies specific to the operation of the motor.

The first root mean square I₁ takes into account all of the samples over the entire frequency range from 0 to 10 kHz or from 0 to 20 kHz in accordance with the sampling range.

However, the root mean square I₂ constitutes an optional correction which only takes into account the vibration frequencies specific to the configuration of the motor.

Finally, the processing chain comprises a comparator 52 which is capable of comparing the indicator Ind calculated by the module 50 with two predetermined threshold values designated Ind₁ and Ind₂ in order to provide at the outlet three values which are representative of the state of the fan, that is to say, at an outlet S₁, a value which indicates that the fan is in good condition, at an outlet S₂, a value which indicates an alarm which predicts a future fracture of one of the bearings in approximately one hundred hours and, at an outlet S₃, a value which indicates an alarm which commands immediate stopping of the fan owing to an imminent fracture of one of the bearings.

When the fan is operational, the sensor permanently measures the parameter which is representative of the dynamic behaviour of the bearings, the sensor being placed as close as possible to one of the bearings. Whichever bearing is becoming damaged, the vibration consequences are detected by the sensor 42, since these phenomena are transmitted via the shaft 26.

Continuously, the parameter measured by the sensor 42 is processed by the processing chain 44 which provides a comparison of the indicator calculated at regular intervals.

Taking into consideration the specific limitations at the fan, the frequency spectrum taken into account for the calculation of the indicator is very wide and in particular comprises frequencies of up to at least 10 kHz and preferably up to at least 20 kHz.

1. Fan comprising a support structure, a wheel, a shaft, a drive motor, and at least one ball-bearing, the wheel being carried by the shaft which is coupled to the drive motor and the at least one ball-bearing which is interposed between the shaft and the support structure, the support structure comprising an outer conduit and a bulb-like portion, the outer conduit enclosing the bulb-like portion, the bulb-like portion being having a chassis for supporting the drive motor and the wheel, the outer conduit and the bulb-like portion delimiting an annular channel for circulation of air which is caused to move by the wheel, the annular channel delimiting an inner space, the fan comprising means for monitoring the fatigue of the at least one bearing,
wherein the means for monitoring the ageing comprise:
a sensor for measuring a mechanical parameter which is representative of the dynamic behaviour of the at least one bearing, which sensor is arranged in the inner space delimited by the annular channel for circulation of the air;
a processing chain which is connected to the measurement sensor and which is capable of calculating at least one indicator which is representative of the vibration behaviour of the at least one bearing based on the parameter measured and evaluating the at least one indicator which is representative of the vibration behaviour of the at least one bearing from the sensor with respect to at least one predetermined criterion.

2. Fan according to claim 1, wherein the measurement sensor is an acceleration meter.

3. Fan according to claim 1, wherein the measurement sensor is a piezoelectric sensor.

4. Fan according to claim 1, wherein the monitoring means comprises a single measurement sensor.

5. Fan according to claim 1, wherein the measurement sensor is pressed directly onto a ring of a bearing.

6. Fan according to claim 1, wherein the measurement sensor is pressed onto the support chassis in the immediate vicinity of a bearing.

7. Fan according to claim 1, wherein the processing chain comprises means for frequency analysis of the mechanical parameter measured by the measurement sensor over a frequency range of between at least 0 and 10 kHz and the indicator which is representative of the vibration behaviour is a function of the frequency components of the parameter measured by the measurement sensor between at least 0 and 10 kHz.

8. Fan according to claim 7, wherein the processing chain comprises means for frequency analysis of the mechanical parameter measured by the measurement sensor over a frequency range of between at least 0 and 20 kHz and the indicator which is representative of the vibration behaviour is a function of the frequency components of the parameter measured by the measurement sensor between at least 0 and 20 kHz.

9. Fan according to claim 7, wherein the indicator which is representative of the vibration behaviour is a root mean square of all of the frequency components of the parameter over the entire frequency range.

10. Fan according to claim 1, wherein the processing chain comprises:
means for frequency sampling of the parameter measured by the measurement sensor;
means for frequency analysis of the parameter measured by the measurement sensor providing a frequency component (Vᵢ) for each frequency;
means for calculating the at least one indicator which is representative of the vibration behaviour in accordance with the frequency components received;
means for comparing the indicator with at least one reference value.
